(19) United States
(12) Patent Application Publication
(10) Pub. No.: US 2005/0106452 A1
(43) Pub. Date: May 19, 2005

(54) Acid stripper

(76) Inventors: Nawaz M. Qureshi, La Mirada, CA (US); William Raymord Schwarz, Santa Fe Springs, CA (US); Edward R. Schwarz, Santa Fe Springs, CA (US)

Correspondence Address: NAWAZ M. QURESHI, 13250 LA SALINA STREET, LA MIRADA, CA, 90638, US

(21) Appl. No.: 10/628,117

(22) Filed: Jul. 28, 2003

(51) Int. Cl. H01M 2/36; B01F 5/06

(52) U.S. Cl. 429/72; 366/339

(57) ABSTRACT

A battery cap device, “Acid Stripper”, to be used in the formation process of battery manufacturing. The cap's design is not applicable for use by the end user of the batteries. During the formation process, the batteries internally generate gasses which vent out from the top cover of the battery, carrying the acid mist with them. The release of this acid mist is an undesirable condition. The vented battery cap or “Acid Stripper” herein consists of a battery cap with gasket on which is welded and attached a static mixing tube. The static mixing tube has a double helix insert that removes the liquid acid and mist carried by the gasses, and drains it back into the battery. This substantially prevents any acid from escaping to the outside of the battery during the formation process. The prevention of the acid escape eliminates the damage to the floor, the environment, the equipment and the people breathing the air.

### BACKGROUND OF THE INVENTION

1. The “ACID STRIPPER” invention relates only to the formation process during the manufacture of batteries. Formation process is the term used in the art of manufacturing batteries whereby the unformed or “green” batteries are filled with the sulfuric acid electrolyte and electrically charged for the first time.

2. During the formation process, the battery cells gas profusely during the second half of the formation time phase, and the intensity of the gas evolution is much more vigorous than in a battery getting an ordinary recharge such as in an engine compartment for the end user. Fairly large volumes of hydrogen and oxygen gasses are generated at the negative and the positive plates respectively from the electrolysis of water. This causes vigorous effervescence in the electrolyte. These gasses carry minute droplets of acid with them in the form an acid laden mist. The acid carried by the mist stays in the formation room in the air, settles down on top of the batteries and their immediate vicinity, settles on the battery racks or tables, settles on the battery clamps and cables, and settles on the formation room floor. The presence of acid at the said locations is undesirable because it causes damage by chemical attack and requires substantial neutralizing and cleanup operations at some cost.

3. Without the use of the ACID STRIPPERS, the process of battery formation, the formation room and the equipment therein is subject to acid presence and erosion from acid attack, and the irritating breathing air, from the aforementioned acid laden mist. The concrete floors are eroded from acid attack and are usually protected by laying down a layer of soda ash to neutralize the acid. The steel tables and racks which hold the batteries are also subject to acid attack and require frequent acid resistant coatings and/or replacement. The presence of acid on the electrical power cables causes the insulation to degrade causing electrical shorts and fires. The cleanup of the acid requires extra costs and extra use of water and is detrimental to the environment. After the formation process, the batteries require substantial washing to remove the acid deposit.

4. The practice to eliminate the acid mist problem has consisted of installing air scrubbing and air conditioning equipment, spray misting, and acid resistant floors. However, this still did not completely remove the irritating acid mist and acid deposits from the room.

5. The prior art was dedicating the regular vent caps to the formation room only. The baffles and porous discs were removed from them such that they would not function as spark arrester safety caps. They were also special color coded to prevent them from being used on the finished batteries.

6. The invention claimed herein requires no special tooling because it is fabricated from two of off the shelf items: one is the bottom part of a battery cap and the other is the static mixer normally used for mixing dissimilar liquids such as epoxy parts A and B. In one embodiment of this invention the battery cap portion used is from the “Lead Acid Safety Cap, U.S. patent application Ser. No. 081978,693, available from St. Calir Plastics, Inc., 10031 Freeman Ave., Santa Fe Springs, Calif. 90670 (Telephone: 562-946-3115). The condenser or the “acid stripper” tube is the second part and is known as a static mixer in the fluid mixing industries. In this embodiment the acid stripper tube is the static mixer part # 261-212 available from TAH Industries, Inc., 8 Applegate Drive, Robbinsville, N.J. 08691 (Telephone: 609-259-9222). To obtain the battery fitting portion of the battery cap, it can be disassembled with a small screw driver by prying out and removing the top disc, the porous disc, and the inserted diverter plate. What remains is the cap body 2 and the gasket 4 and 1 respectively. The static mixer 2 and the cap body 3 are spin welded, or hot melt welded, together to make the device.

7. The object of the present invention is to provide a battery cap incorporating the acid removal system for the exclusive use in the battery formation process. The acid stripper device is cannot be used by the end user of the batteries because of its physical size. Another objective is the superior separation, collection and return of the electrolyte positively back into the battery. Yet another objective is the elimination of the acid from the formation room environment from the air, from the floor and from the outside of the battery surfaces and the surrounding areas. This substantially improves the environment of the formation room, and eliminates the need to neutralize and dispose off the unwanted acid thereby creating a much cleaner environment and eliminating the acid deposits clean up costs.

### A BRIEF DESCRIPTION OF THE DRAWINGS

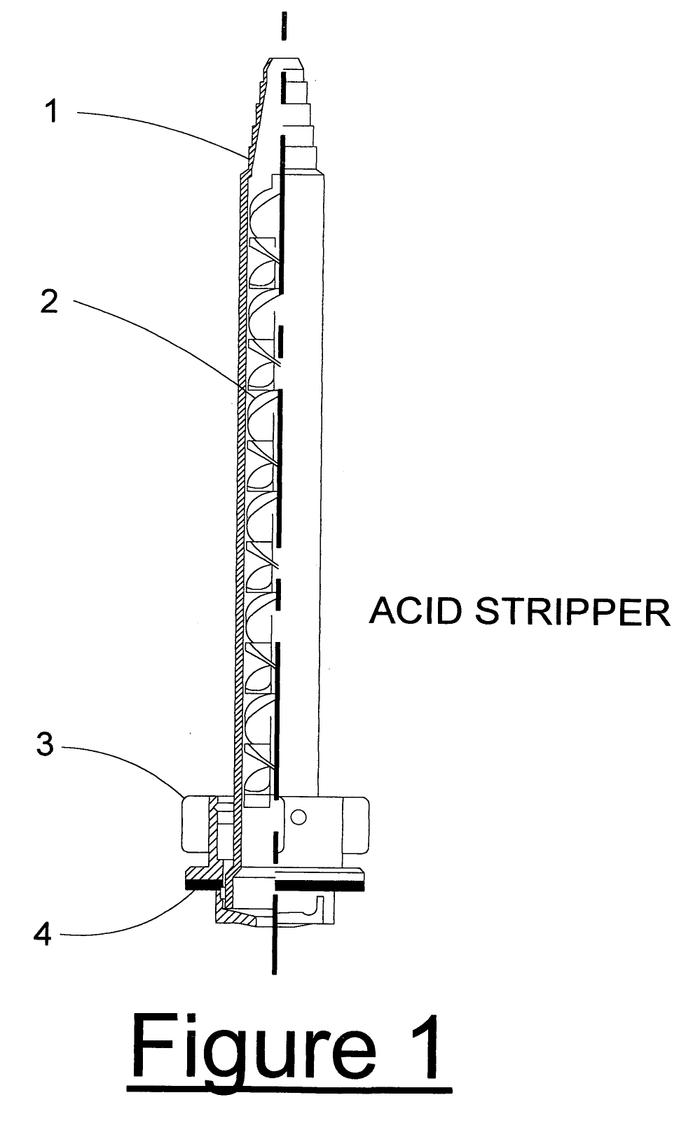

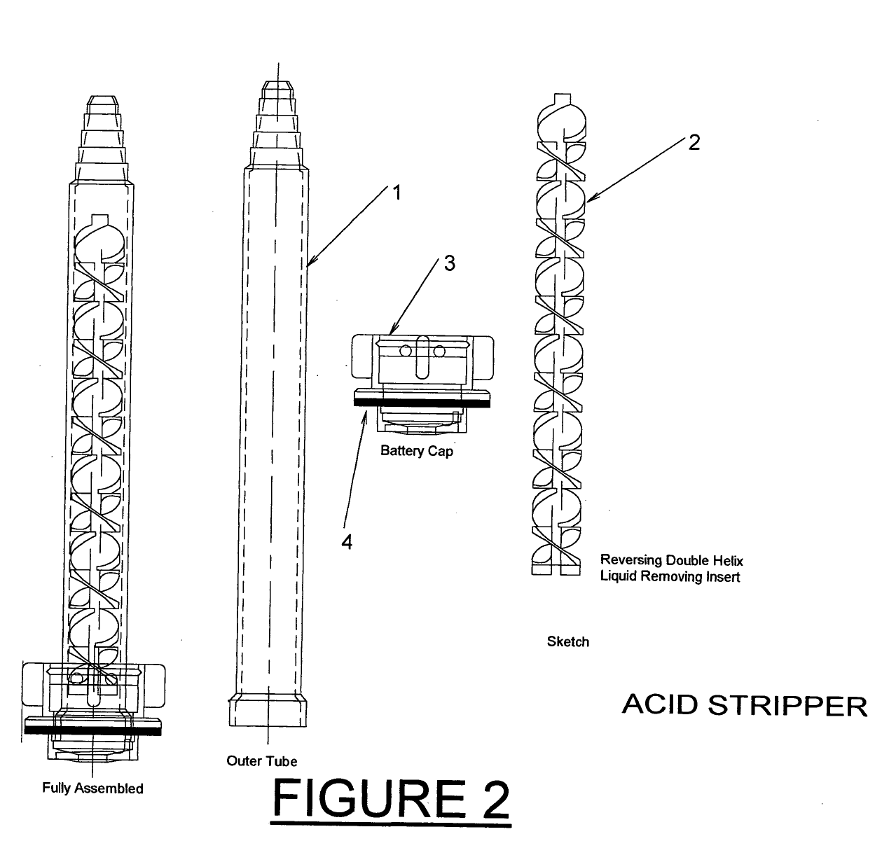

1. A functional understanding of the mechanism of the present invention can be accomplished by viewing a cut away view, half section, in FIG. 1 and the parts and fully assembled drawing in FIG. 2.

FIG. 1 has the half section showing the following:
#1 is the outer tube.
#2 is the reversing double helix insert to separate and remove the liquid
#3 is the cap body
#4 is the rubber gasket.

FIG. 2 shows the parts and the full assembly of the ACID STRIPPER.
#1 is the outer tube.
#2 is the reversing double helix insert to separate and remove the liquid
#3 is the cap body
#4 is the rubber gasket.

### DESCRIPTION OF THE PREFERRED EMBODIMENT OF THE INVENTION

1. Proceeding to the detailed description of the ACID STRIPPER invention in FIG. 1, the Half Section drawing the fully assembled and cut away half section views simultaneously. Generally the body cap 3 is a battery vent cap. The said cap normally made for closure of the batteries with a disc on top for closure and a flame arrestor porous disc below that and a diverter plate below that. The closure disc, the porous disc, and the diverter plates are removed or not assembled for this application. Just the cap body 3 and the rubber gasket 4 is used as part for the assembly.

2. The rubber gasket 4 is a flat rubber washer fabricated by the lathe cut process. The gasket seals against the gas and acid leaks at the cap and battery cover interface, said seal is firmly held in place by the mechanical breach lock pressure created at the bottom of the cap 3 by the breach lock with the battery cover.

3. In this example the cap and the ACID STRIPPER are employed on installation on a battery cover with approximately 1.2 inch diameter cell filling ports. The said ports are standardized with two opposing flanges which engage the breach lock at the bottom of the cap body 3. The one quarter turn will securely fasten and seal the storage battery filling port at clockwise rotation. The cap body of the LEAD ACID BATTERY SAFETY BATTERY CAP, FIG. 1, labeled 3, has four (4) protruding wings or vanes which enable the easy grasping of the cap body 3 for quick installation and removal of the ACID STRIPPER from the battery filling ports of the lead acid storage batteries.

4. The lead acid batteries consist of cells (or compartments) filled with aquous solution of sulfuric acid (also called battery electrolyte). The lead acid battery cell will produce a nominal 2 Volts. The technology parlance, when the cells are internally connected in series circuit to produce a higher Voltage, it is called a battery.

5. There is process in lead acid battery manufacturing called the Formation Process. In this process, a specified aqueous solution of sulfuric acid is added to each cell of the unformed or “green” battery, it hooked up to a direct current source (usually in series with several other batteries) and a current is passed through the battery for the very first time in the charging direction. During the formation process, the lead sulfate and other compound convert to the battery active materials on the negative and the positive plates, namely spongy lead and lead dioxide respectively.

6. When batteries are charged or go thorough the Formation Process, the individual cells vigorously gas during the second half of the formation cycle time. Fairly large volumes of hydrogen and oxygen gasses are generated and generated at the negative and the positive plates respectively as result of the electrolysis of water in the solution. The effervescence thus created carries droplets of the acid electrolyte with it as it leaves the cells. In the prior art, the acid solution (or the electrolyte) would spit out, as well as escape in form of acid mist and settle down on top of the batteries, on the connecting cables and clamps, on the battery pallets, tables or racks, and on the formation room floor. The acid mist can also be readily detected by personnel working and entering the formation room because it irritates the mucous membranes in nose and throat.

7. When the present invention the ACID STRIPPER is installed to each cell of the battery from the cap body, FIGS. 1 and 3, the direct pathway for the liquid and gas is to the outside of the battery is sealed by the gasket 4. The only escape path for the gasses, the acid and the acid mist is up through the double helix liquid removing insert 2 inside the tube 1. The tube body 1 is spin welded to the cap body 3 to fabricate the ACID STRIPPER.

8. The acid electrolyte and gas mixture can only move in an upward direction encountering the surfaces of the reversing double helix and walls of the tube. Each spiral section of the double helix insert comprises of 180 degrees of travel by the mist in clock wise direction and the next section is 180 degrees rotational travel in the counter-clockwise direction. In one instance the insert comprises 18 such sections assuring a substantial separation of the liquid from the mist as it ascends through the pathways to the top of the tube 1. The mist comprising of gas and liquid plays on the large surfaces provided by the spiral staircase like ribbons, arresting the liquid portions and prolonging the escape time of the exhausts.

9. As each 180° counter rotation completes the full circle of 360° coverage of the projected areas, it is met with yet another chamber. Each chamber represents the aforementioned process with a plurality of condensation chambers, slowing and separating the liquid from the gasses. The forming liquid droplets get bigger and heavier, the start to roll downward from gravity and eventually drain back into the cells. This provides a substantial separation of the acid from the mist and positive drain back of the acid electrolyte back into the battery cells.

10. The acid laden gasses can move only in the upward direction encountering the surfaces presented by the spiral staircase double helix. By rotating the flow in opposite directions, the separation of liquid from the gasses becomes much more effective. Interconnecting multiple chambers in the path assures more complete separation of the liquid from the gasses.

11. There is sufficient space provided in each condensation chamber of the double helix insert 2, such that path of the cannot be blocked by a “plug” of liquid formed by surface tension, allowing the liquid to freely drain back into the cell and allowing the gasses to freely escape from the top of the tube 1.

1. I claim a designed battery cap called The ACID STRIPPER exclusively for the formation process in battery manufacturing, comprising of a battery cap body with breach lock, gasket insert, inertial spin welded, or hot melt welded, to an outer tube which is inserted with reversing double helix liquid removing device consisting of spiral staircase like ribbons with two helixes that reverse rotational direction. The helixes complete 180° rotation each to complete 360° to form a chamber and consisting of about 12 such interconnected chambers, providing a pathway for the electrolyte fumes towards the exhaust for the gasses on top of the outer tube.

2. An ACID STRIPPER as defined in claim 1 to be made of acid resistant thermoplastic material such as polypropylene or poly ethylene suitable for inertia or spin welding.

3. An ACID STRIPPER cap as defined in 1 which can readily be distinguished from an end user cap by the presence of ling chimney like tube on top which encloses the liquid separation insert. Such inserts can be any shapes, such balls or discs, that increase the acid mist path and provide the surface to separate the liquid from the gases and drain it back into the battery cells.

4. An ACID STRIPPER that is fabricated from the available components in the battery and mixer part used in epoxy and mixing applications, consisting of a battery cap body and a static mixer respectively.

5. An ACID MIXER consisting of attached long high internal surface area tube with liquid separation enclosure rising vertically from the battery cap body.

6. An ACID STRIPPER enclosing the reversing double helix liquid removing insert.
